(19) United States
(12) Patent Application Publication
(10) Pub. No.: US 2008/0304268 A1
(43) Pub. Date: Dec. 11, 2008

(54) Reflector

(76) Inventor: Ivan To, Drayton Valley (CA)

Correspondence Address: DAVIS BUJOLD & Daniels, P.L.L.C., 112 PLEASANT STREET, CONCORD, NH, 03301, US

(21) Appl. No.: 11/995,357

(22) PCT Filed: Jul. 11, 2005
(86) PCT No.: PCT/CA2005/001068

§ 371 Date: Jan. 11, 2008

(51) Int. Cl. G02B 5/12

(52) U.S. Cl. 362/341

(57) ABSTRACT

A reflector in the form of a body having a reflective surface. A recessed cavity is provided in the body having a viewing opening in the reflective surface. The cavity is filled with light emitting luminescent material which emits light visible through the viewing opening.

### FIELD OF THE INVENTION

The present invention relates to reflectors used to make vehicles more visible at night or objects along a road at night.

### BACKGROUND OF THE INVENTION

A reflector is used to reflect light and, thereby, enhance the visibility of vehicle. Advancements have been made in reflector technology to improve light reflection patterns. A problem remains, however, that a reflector generally is not fully visible at night until a light strikes it.

### SUMMARY OF THE INVENTION

What is required is a reflector which has enhanced visibility at night.

According to the present invention there is provided a reflector is in the form of a body having a reflective surface. A recessed cavity is provided in the body having a viewing opening in the reflective surface. The cavity is filled with light emitting luminescent material which emits light visible through the viewing opening.

With the reflector, as described above, state of the art reflector technology is provided on the reflective surface. In addition, a concentration of luminescent material is provided in a recessed cavity, which emits a visible light through the viewing window. The luminescent light source, provides an additional dimension to the reflector.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a top plan view of a reflector constructed in accordance with the teachings of the present invention.

FIG. 2 is a side elevation view, in section of the reflector illustrated in FIG. 1.

FIG. 3 is a top plan view of a variation of a reflector.

FIG. 4 is a side elevation view of the variation in FIG. 3.

FIG. 5 is a top plan view of another variation of a reflector.

### DETAILED DESCRIPTION OF THE PREFERRED EMBODIMENT

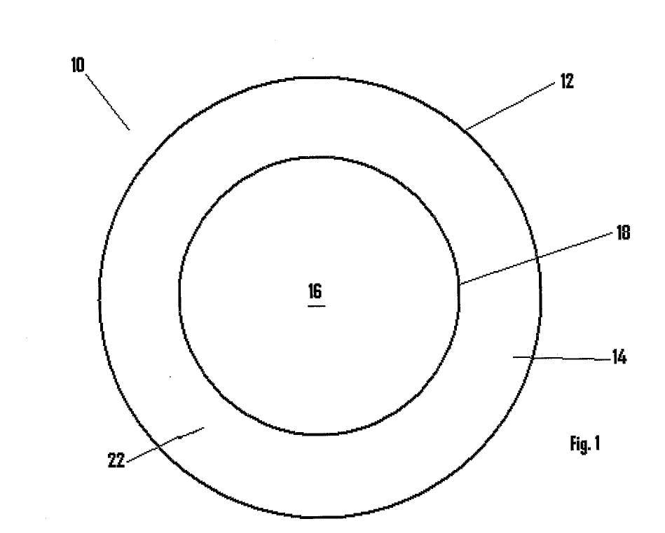

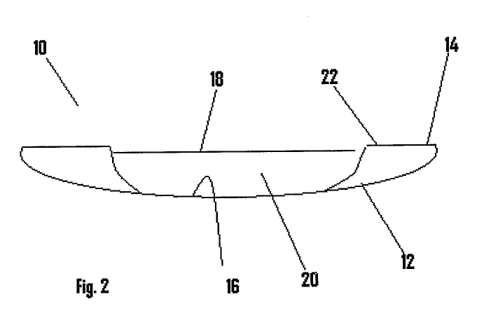

The preferred embodiment, a reflector generally identified by reference numeral 10, will now be described with reference to FIGS. 1 and 2.

Structure and Relationship of Parts:

Referring to FIG. 1, reflector 10 includes a body 12 having a reflective surface 14. Referring to FIG. 2, a recessed cavity 16 is provided in body 12. Referring to FIG. 1, recessed cavity 16 has a circular viewing opening 18 in reflective surface 14. Referring to FIG. 2, recessed cavity 16 is filled with light emitting luminescent material 20. This luminescent material 20 emits light which is visible through viewing opening 18. Referring to FIG. 1, viewing opening 18 is centrally positioned on reflective surface 14. Reflective surface 14 forms an annular reflective border, generally indicated by reference numeral 22, which surrounds viewing opening 18.

Operation:

Referring to FIG. 1, when light strikes reflector 10 it reflects the light off reflective surface 14 all along annular reflective border 22. Referring to FIG. 2, even when the light is at a bad angle or too far away to create a reflection, light is emitted by luminescent material 20 which is visible through viewing window 18.

Variation:

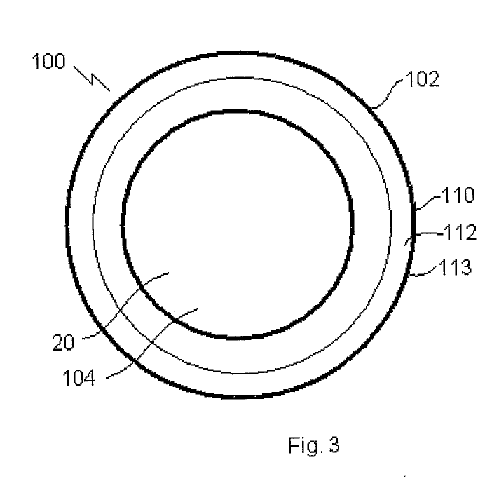

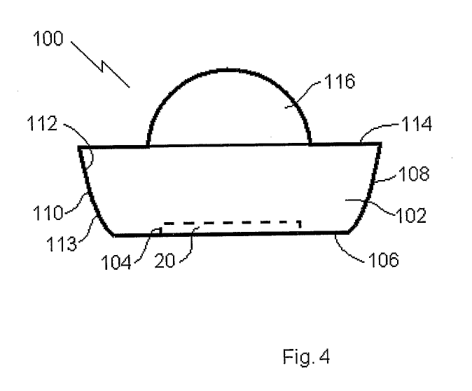

Referring to FIG. 3, an alternate embodiment is shown. The body 102 of reflector 100 is formed of a transparent material such as glass. In this embodiment, referring to FIG. 4, a cavity 104 in body 102 is filled with light emitting luminescent material 20 from the bottom 106, and bottom 106 and the sides 108 are then coated with a coating 110. Coating 110 forms a reflective surface 112 on the inside, and a protective layer 113 on the outside. On the top 114 of body 102 is a glass dome 116 which helps direct light from reflective surface 112 and from luminescent material 20. This reflector is suitable to be embedded in roadways or walkways. As such it provides warning bumps on roadways if a driver begins to drift off the road, and also marks the edge of the roadways and walkways with the reflected and emitted light.

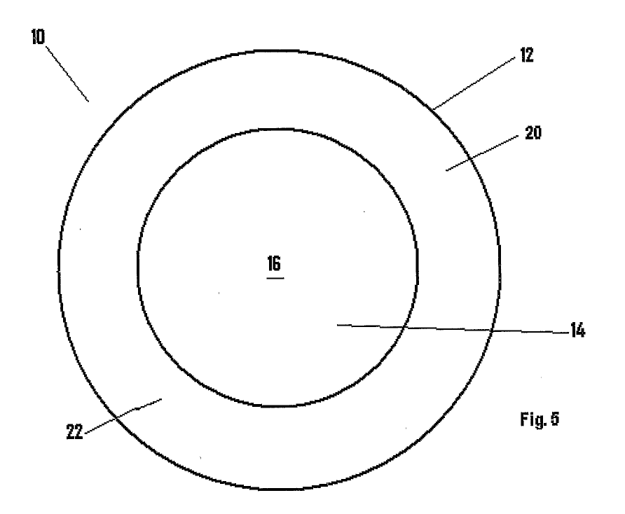

Referring to FIG. 5, another variation is shown, where light emitting luminescent material 20 is located on the outside of body 12, and reflective surface 14 is on the inside. These variations illustrate that the invention allows for different arrangements, depending upon preference and the situation in which they are used.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A reflector, comprising:
a body having a central portion and a peripheral border;
the central portion being one of a reflective surface or a luminescent surface; and
the peripheral border being another of the reflective surface or the luminescent surface.

2. The reflector as defined in claim 1, wherein the luminescent surface is a recessed cavity in the body filled with light emitting luminescent material.

3. The reflector as defined in claim 2, wherein the central portion has the luminescent surface and the peripheral border has the reflective surface.

4. The reflector as defined in claim 3, wherein all of the body has the reflective surface and a viewing window is provided in the reflective surface of the body through which light emitted by the luminescent surface is visible.

5. The reflector as defined in claim 4, wherein the viewing window is circular and the peripheral border is annular.
